(19) United States
(12) Patent Application Publication
(10) Pub. No.: US 2009/0116489 A1
(43) Pub. Date: May 7, 2009

(54) METHOD AND APPARATUS TO REDUCE DATA LOSS WITHIN A LINK-AGGREGATING AND RESEQUENCING BROADBAND TRANSCEIVER

(76) Inventor: William Turner Hanks, Carol Stream, IL (US)

Correspondence Address: ARRIS INTERNATIONAL, INC, 3871 LAKEFIELD DRIVE, SUWANEE, GA, 30024, US

(21) Appl. No.: 12/245,635

(22) Filed: Oct. 3, 2008

Related U.S. Application Data
(60) Provisional application No. 60/977,243, filed on Oct. 3, 2007.

(51) Int. Cl. H04L 12/56

(52) U.S. Cl. 370/394

(57) ABSTRACT

A rate shaper between a transmit queue and a transmitter regulates the flow rate of packets through a resequencing broadband transmission device, such as a cable modem, toward a user device, such as a computer. When the resequencing device receives packets out of order that belong to a program flow spread across multiple links, or channels, the rate shaper regulates the flow of packets by imposing a delay to the flow of resequenced packets by a factor that is inversely proportional to the number of out of sequence packets buffered in a message storage buffer. A setpoint signal may be input to the shaper to provide a target flow rate to the shaper.

### CROSS REFERENCE TO RELATED APPLICATION

This application claims priority under 35 U.S.C. 119(e) to U.S. provisional patent application No. 60/977,243 entitled “Method and apparatus to reduce data loss within an link-aggregating and resequencing broadband transceiver,” which was filed Oct. 3, 2007, and is incorporated herein by reference in its entirety

### TECHNICAL FIELD

The claimed subject matter relates to communications networks, and more particularly, to managing the data rate of a broadband traffic flow that uses multiple broadband channels for transmission

### BACKGROUND

Service providers, such as multiple services operators (“MSO”), a term used by some to refer to cable TV network operators, sometimes use a form of multiple-link aggregation to meet the increasing demands of broadband data bandwidth. Multiple-link aggregation technology combines multiple transmission paths each with an average bandwidth rate of “r” to feed a combined transmission path of bandwidth rate “R” (typically R>>r). Many implementations of multiple-link aggregation make no attempt to keep messages in order as the messages are passed across multiple parallel transmission paths. However, some implementations number the messages of a “sequencing context” before they transmit message traffic packets on one of several transmission paths; the receiver then resequences the message packets if necessary before forwarding the messages along the combined transmission path on to their final destination.

Turning now to the figures, FIG. 1 shows an example of a multiple-link aggregation system 2. In FIG. 1, the link-aggregating and resequencing broadband transceiver (“RBT”) 4 receives broadband data traffic from multiple smaller bandwidth paths 6 from a link aggregating and resequencing broadband transmission device 8, such as, for example, a CMTS processing traffic packets according to the Data Over Cable Service Interface Specification (“DOCSIS”) version 3.x, resequences each packet, or data messages, from the traffic flow according to a sequence number that has been inserted into each packets, and then strips off the sequencing information and transmits the remaining portions of the messages over combined transmission path 10 according to sequencing order towards Application Appliance Device 12, an example of which may be a cable modem (“CM”) that receives transmissions from a cable modem termination system (“CMTS”).

Showing more detail, FIG. 2 illustrates a block diagram of a transceiver representative of transceiver 4 shown in FIG. 1. In FIG. 2, multiple lower-bandwidth receivers 14 receive multiple Numbered Messages (which may be out-of-order) from links 6 to message sequencer 15. Message sequencer 15 examines the sequencing information in an arriving message packet to determine whether it matches the next expected message packet number.

If a new message contains the next expected sequence number then the message is already in order and is placed directly into Tx Queue 16 as a properly Sequenced Message. Message Resequencer 15 then retrieves any Fended Sequenced Message from message storage buffer 17 which now matches the next expected message number, and places the pended sequence message directly into Tx Queue 16 as a properly Sequenced Message. This last step is repeated as necessary until no Pended Sequenced Message matches the next expected message number.

If the new Numbered Message contains a sequence number lower than the next expected message number then it is considered to have been previously lost and is discarded. If the new message contains a sequence number which is greater than the next expected message number then it has arrived out-of-order and message resequencer 15 places it into Message Storage buffer 17 as an Out-of-order Message.

If an amount of time passes that is equal to a “Maximum Resequencing Wait Time” before a message with the next expected message number arrives, then Message Resequencer 15 examines Message Storage buffer 17 to see if it is empty. If resequencer 15 determines that buffer 17 is empty, then Transceiver 4 has nothing left to transmit and it waits for a new Numbered Message to arrive. If Message Storage buffer 17 was not empty, then Message Resequencer 15 identifies the next expected message as lost by incrementing a next expected message number counter and then, reexamining the Message Storage buffer 17 for a Fended Sequenced Message that matches the new expected message number and placing it directly into the Tx Queue 16 as a properly Sequenced Message. This last step is repeated as necessary until no Fended Sequenced Message matches the next expected message number.

Finally, tranceiver's 4 Transmitter 18 retrieves one Sequenced Message at a time from Tx Queue 16 and transmits the message. Transmitter 18 repeats this last step until Tx Queue 16 is empty. Once Tx Queue 16 is empty, transmitter 18 waits for a new Sequenced Message to be placed onto the Tx Queue 16.

Anytime a tranceiver 4 attempts to (re)establish a message sequence, it will buffer messages for up to a Maximum Resequencing Wait Time. An operator may define The Maximum Resequencing Wait Time as a long period, depending on the characteristics of the multiple links that are used for aggregation. If system 2, illustrated in FIG. 1, loses even one message during a high-bandwidth transfer, the system, will store the majority of the high-bandwidth transfer message packets in Message Storage buffer 17 until the Maximum Resequencing Wait Time elapses after the system, or network that transfers traffic flows into it, loses the one message. Once the Maximum Resequencing Wait Time expires, the Resequencer 35 will operate continuously until the entire Message Storage buffer 17 empties and the Transmit Queue 16 contains most of the high-bandwidth transfer message packets.

Meanwhile, transmitter 18 removes message packets from transmit queue 16 and transmits them as fast as outbound link 10 supports. Operating transmitter 18 at its maximum rate results in a burst of data packets equal in size to the number of messages stored in the message storage buffer 17. Transmitter 18 transmits such a burst at the full line rate R of combined transmission path 10.

As an example, assume a system having four links 6 with an average rate r=25 Mb/s (25×10⁶ bits/second). In addition, assume that an operator sets Maximum Resequencing Wait Time to 18 milliseconds. Further assume that transceiver 4 transfers a very large amount of data that will fully use this capacity for slightly longer than the Maximum Resequencing Wait Time. Also, assume an output link rate R=1 Gb/s (1×10⁹ bits/seconds). If one of the very first messages gets lost, then transmitter 18 may transmit an amount of data equal to 4×25×10⁶×0.018 seconds, or 18 million bits (225 kbytes), as a burst from combined transmission path 10. With an output link speed of 10⁹ bits/s, all 1.8 million bits (225 kbytes) of this can arrive at the application appliance device in 1.8 ms. Transceiver 4 will lose data if the Application Appliance Device coupled to combined transmission path 10, for example, a vintage 2005 desktop PC running MS Windows XP, cannot receive and process such a large burst in such a short time.

In addition, MSOs typically prefer that their subscribers do not tweak default settings of their computer protocol stacks to achieve better channel bonding throughput performance.

### DESCRIPTION OF THE DRAWINGS

FIG. 1 illustrates a system, for aggregating multiple traffic links and outputting the combining traffic from same over a combined transmission path.

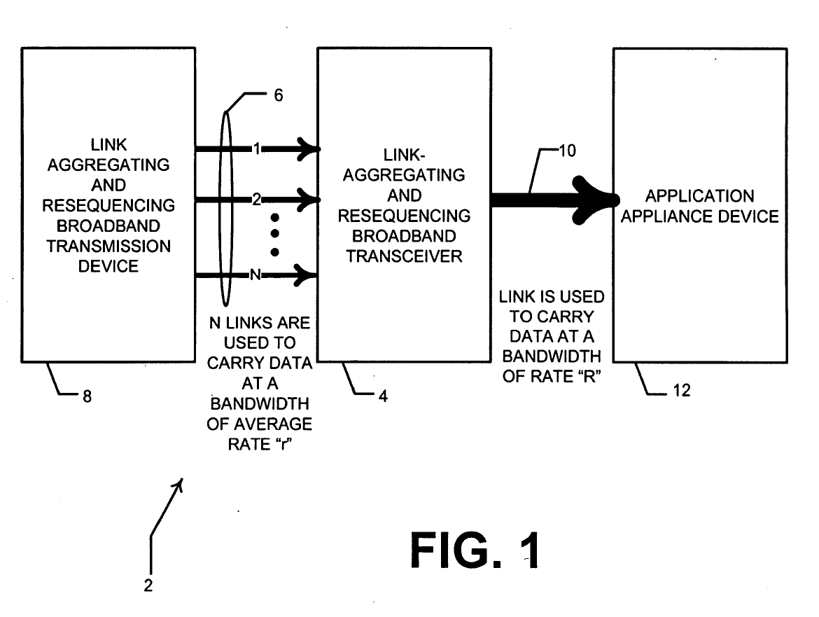

FIG. 2 illustrates a link-aggregating and resequencing broadband transceiver used in a system for aggregating multiple traffic links.

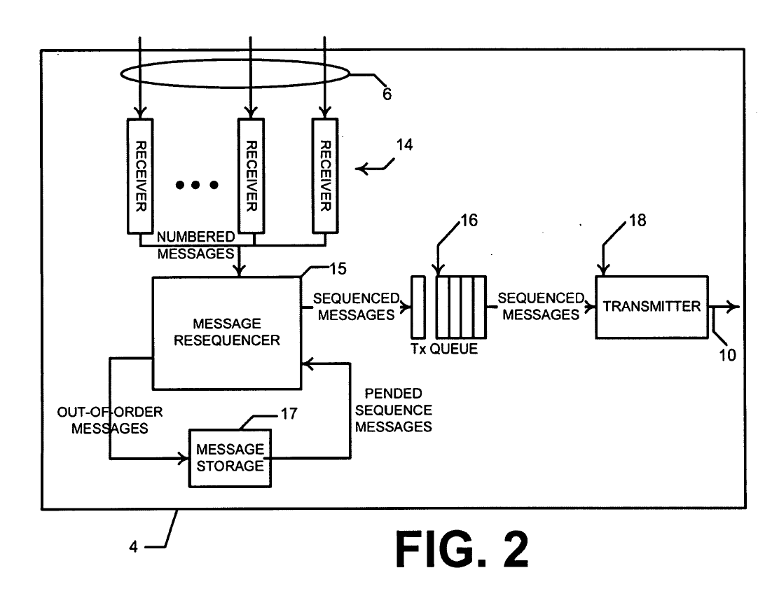

FIG. 3 illustrates a link-aggregating and resequencing broadband transceiver with a rate shaper.

FIG. 4 illustrates a token bucket.

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. The following disclosure is not intended nor is to be construed to limit the present invention or otherwise to exclude any such other embodiments, adaptations, variations, modifications and equivalent arrangements, the present invention being limited only by the claims appended hereto and the equivalents thereof.

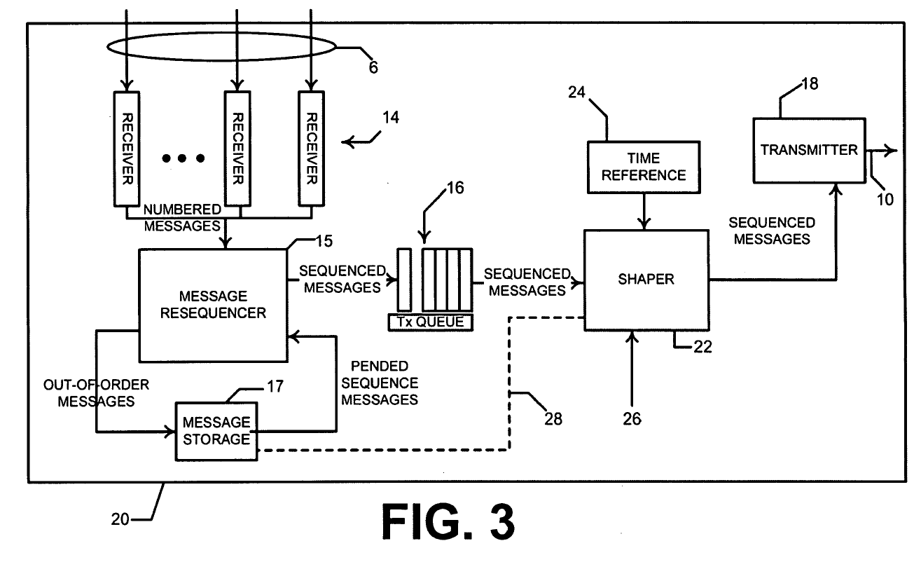

Returning now to the figures, FIG. 3 illustrates a transceiver that uses a rate shaper 22 between transmit queue 16 and transmitter 18. Rate shaper 22 between transmit queue 16 and transmitter 18 can smooth, or shape, a flow of message packets for transmission along combined transmission path 10. Rate shaper 22 may process, or shape, message packets fed to transmitter 18 to keep the output, flow rate therefrom below a predetermined peak output rate. Rate shaper 22 bases the predetermined peak output rate on an assumption that only ‘burstiness’ caused by resequencing needs smoothing. Thus, the increase in effective bandwidth achieved through advantageous use of multiple channels to transmit a given program traffic flow does not impose unpredictable flow patterns. The more predictable traffic packets flow, the more efficiently networks operate, thus reducing the cost, and amount, of equipment a network operators needs to provide a given minimum, level of service.

IETF Request for Comment (“RFC”) 2475, which is incorporated herein by reference in its entirety, defines a rate shaper as:
[s]hapers delay some or all of the packets in a traffic stream in order to bring the stream into compliance with a traffic profile. A shaper usually has a finite-size buffer, and packets may be discarded if there is not sufficient buffer space to hold the delayed packets.

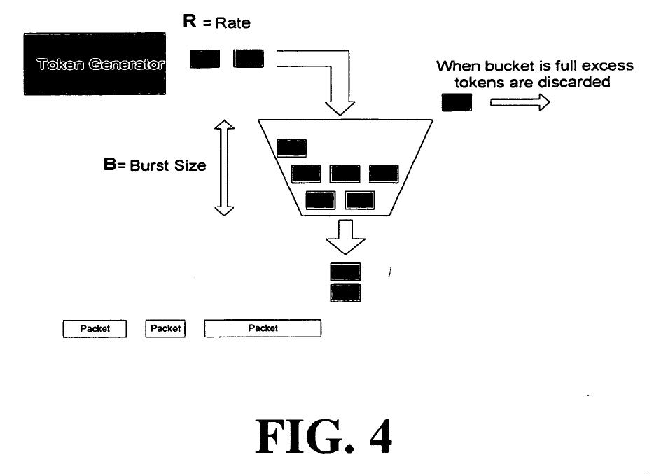

A token bucket, illustrated in FIG. 4, is one possible example of a rate shaper. Those skilled in the art will understand the function of a token bucket, but this application provides a brief conceptual description here of a token bucket. A Token Bucket is a conceptual entity that is filled up with, tokens dispensed by a Token Generator at a rate of R, perhaps one token represents one data packet, or a token may represent one byte of data. The bucket has a certain depth, B, in bytes. An incoming packet is allowed to be transmitted if there are sufficient byte tokens in the bucket. In the case where there is a burst of data, all the data may be allowed to pass at line rate if there are sufficient tokens in the bucket. This may result in a bursty flow; a single token bucket does not provide for consistent rate shaping. It is implementation specific if a packet is dropped or queued (delayed) when there are insufficient tokens, For this application, the packet would be queued.

A token is placed in the Token Bucket at rate R. The bucket will accept tokens up to the limit B. When this limit is reached, no more tokens will be added to the bucket; tokens will be discarded until tokens are taken from the bucket. For example, if no user data is passing then the bucket will fill up and tokens will constantly be discarded; when data begins to flow, tokens will be taken from the bucket, and hence, additional tokens from the token generator will then be added to the bucket.

As a packet arrives, the shaper will remove a number of tokens from the bucket equal to the size of the packet in bytes to satisfy the value needed to pass the packet. If there are insufficient tokens available in the bucket the packet is buffered until there are sufficient tokens available.

A large value of B, (i.e, the bucket can potentially store a large number of tokens) which an operator may set if a flow experiences a burst of traffic (e.g. a user starts a download of a large file), then the flow may comprise traffic at a rate greater than R.

Shaper 22 processes message packets with transmit queue 16 performing the function of the “finite-size buffer” described in RFC 2475, and based on a further assumption that the transmission queue has a capacity at least equal to Message Storage buffer 17. Otherwise, storage buffer 17 could be forced to discard packets that transceiver 20 received out of order if rate shaper 22 slows output toward transmitter 18 when attempting to minimize change in output traffic flow rate (i.e., reducing burstiness). With a small token bucket size B, such an arrangement can smooth the output burst over a longer period but at a slower rate that the Application Appliance Device can support. Time reference block 24 may represent a stand alone clock that provides a basis for determining the speed, or rate, that shaper 22 takes in, and sends out, packets. Time reference block 24 may also represent timing signals received from a network that transceiver 20 couples to.

An input 26 to rate shaper 22 may receive a setpoint signal from an operator, or user, either manually, or automatically, from a network device. If a user enters a setpoint at input 26, the setpoint signal sets a target rate at which the rate shaper allows packets to exit towards transmitter 18 on combined transmission path 10. A message storage sensing link 28 may connect message storage buffer 17 to rate shaper 22 so that the storage buffer provides feedback to the rate shaper. As message buffer 17 fills up and buffers more packets, rate shaper 2 should impose less delay in outputting packets it receives from transmit queue 16. On the other hand, as message storage 17 empties, rate shaper 22 should impose more delay on. the outputting of packets received from transmit buffer 16. Accordingly, as message packet resequencer 15 receives more packets out of sequence, and thus stores more packets to message storage buffer 17, rate shaper 22 imposes less of a restriction on the outputting of packets therefrom. And, as message packet resequencer 15 receives fewer packets out of sequence, and thus stores fewer packets to message storage buffer 17, rate shaper 22 imposes more of a restriction on the outputting of packets therefrom. Therefore, rate shaper 22 effectively can close the gap between changes in flow rate through transceiver 20 that result from varying numbers of out-of-sequence message packets received over multiple links 6. Even if rate shaper 22 regulates the flow rate through transceiver 20 to a rate slightly slower than the aggregate rate of packets flowing into message resequencer on multiple links 6 over a given period, the more steady, and predictable, flow rate reduces burstiness that could negate some of the advantage that channel bonding and multiple channel traffic flows for a single program flow can provide.

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents.

What is claimed is:

1. A resequencing broadband transmission device having a rate-shaping device between a transmit queue and a transmitter portion of the resequencing broadband transmission device, wherein the rate shaping device regulates the flow of packets to be transmitted from the transmitter by regulating burstiness caused by resequencing of packets that the resequencing broadband transmission device receives out of order.

2. The resequencing broadband transmission device of claim wherein the broadband transmission device comprises a cable modem.

3. The resequencing broadband transmission device of claim 1 wherein the transmit queue has a capacity at least equal to the message storage size of a resequencing message storage buffer.

4. The resequencing broadband transmission device of claim 1 configured to receive a program traffic flow via multiple channels according to as IEEE 802.3ad link aggregation.

5. The resequencing broadband transmission device of claim 1 configured to receive a program traffic flow via multiple channels according to DOCSIS 3.0 channel bonding.

6. The resequencing broadband transmission device of claim 1 wherein the transmitter portion provides an out put on a combined transmission path that couples to an output port.

7. The resequencing broadband transmission device of claim 6 wherein the output port comprises an Ethernet connection.

8. A system for transmitting a message flow using multiple channels over a communication network from a central network device to a resequencing broadband transmission device having a rate-shaping device between a transmit queue and a transmitter portion of the resequencing broadband transmission device, wherein the rate shaping device regulates the flow of packets to be transmitted from the transmitter by regulating burstiness caused resequencing of packets that the resequencing broadband transmission device receives out of order.

9. The system of claim 8 wherein the broadband transmission device comprises a cable modem.

10. The system of claim 8 wherein transmit queue of the resequencing broadband transmission device has a capacity at least equal to the message storage size of a resequencing message storage buffer.

11. The system of claim 10 wherein the resequencing broadband transmission device is configured to receive a program traffic flow via multiple channels according to as IEEE 802.3 link aggregation.

12. The system of claim 8 wherein the resequencing broadband transmission is configured to receive a program traffic flow via multiple channels according to DOCSIS 3.0 channel bonding.

13. A method for regulating packet flow rate through a resequencing broadband transmission device that aggregates sequential packets belonging to a program flow that are transmitted in a plurality of channels over a communication network, comprising:
receiving at the resequencing broadband transmission device a packet from one of the plurality of channels;
determining whether the packet was received in order according to a sequence value that corresponds to the packet's proper sequence in the program flow;
storing the packet to a message storage buffer if the packet was received out of order;
forwarding one, or more, packets that have been stored in the message buffer to a transmit queue when one or more packets that precede, according to sequence values, the one, or more, packets that have been stored in the message storage buffer are received at the resequencing broadband transmission device;
receiving a message storage buffer depth signal from the message storage buffer that represents the number of packets stored in the message storage buffer; and
imposing delay on the flow rate of packets passing from the transmit buffer to a transmitter, which forwards packets toward a user device, inversely with respect to the number of bytes stored in the message storage buffer.

14. The method of claim 13 wherein a token bucket imposes the delay on the flow rate of packets.

15. The method of claim 13 wherein a setpoint signal provides a target rate for the resequencing broadband transmission device to forward packets toward the user device.
